(19) United States
(12) Patent Application Publication
(10) Pub. No.: US 2022/0317091 A1
(43) Pub. Date: Oct. 6, 2022

(54) Monitoring Deposition in Fluid Flowlines that Convey Fluids During Wellbore Operations

(71) Applicant: Halliburton Energy Services, Inc., Houston, TX (US)

(72) Inventors: David Bennett, Conroe, TX (US); Sean Daly, Houston, TX (US); Chris Fudge, Geismar, LA (US); Derek Latiolais, Lafayette, LA (US); Stephen Horner, Houston, TX (US); Philippe Prince, Houston, TX (US); Oluwatosin Ogundare, Katy, TX (US)

(21) Appl. No.: 17/220,496

(22) Filed: Apr. 1, 2021

(51) Int. Cl. G01N 29/07; G01N 29/04; F17D 5/00; G05B 19/416; E21B 47/06

(52) U.S. Cl. CPC G01N 29/07; G01N 29/043; F17D 5/00; G05B 19/416; E21B 47/06; G01N 2291/0256; G05B 2219/45129; E21B 2200/20

(57) ABSTRACT

A system can control a transmission of a pressure signal subsea into a flowline comprising a fluid. The system can receive sensor data indicating one or more properties of a first reflection signal corresponding to the pressure signal in the flowline. The system can adjust a model based on the one or more properties of the first reflection signal. The model can be configured for determining a presence of a material deposition in the flowline. The system can determine, based on a second reflection signal and the adjusted model, a presence of the material deposition in the flowline. The system can output a command configured to initiate a remediation operation to reduce the material deposition in the flowline.

### TECHNICAL FIELD

The present disclosure relates generally to wellbore operations and, more particularly (although not necessarily exclusively), to monitoring depositions in fluid flowlines that convey fluids during wellbore operations.

### BACKGROUND

Hydrocarbon exploration is the search for hydrocarbons, such as oil or gas, within a subterranean formation. The subterranean formation may be on-shore or offshore. A flowline into the subterranean formation may be used to carry fluids, such as drilling fluid and mud for drilling operations or production fluids from a well. The fluids may be single-phase fluids or multi-phase fluids, such as fluids including multiple substances, air bubbles, and laminar fluids. In some cases, depositions, or a build-up of fluid particulates, may occur throughout the flowline. Depositions may interfere with and reduce productivity of wellbore operations.

### BRIEF DESCRIPTION OF THE DRAWINGS

FIG. 1 is a schematic diagram of an example of an off-shore drilling environment with a flowline for carrying fluids according to some aspects of the present disclosure.

FIG. 2 is a block diagram of an example of a system for monitoring depositions in fluid flowlines according to some aspects of the present disclosure.

FIG. 3 is a diagram of an example of an expected reflection signal and an observed reflection signal according to some aspects of the present disclosure.

FIG. 4 is a diagram of an example of an expected reflection signal and an observed reflection signal according to some aspects of the present disclosure.

FIG. 5 is a flowchart of an example of a process for monitoring depositions in fluid flow lines that convey fluids during wellbore operations according to some aspects of the present disclosure.

### DETAILED DESCRIPTION

Certain aspects and examples of the present disclosure relate to monitoring for material deposits in flowlines used for conveying fluids during well operations, such as drilling operations and production operations. The fluids can be multi-phase fluids, which include a combination of multiple fluids having multiple phases, such as liquids and gasses. The fluids may also carry solid particulates. The well operations may be performed onshore or offshore. For example, the well operations may include a subsea drilling operation, which can be a drilling operation occurs offshore and below a sea floor. The techniques described in the present disclosure may accurately detect the build-up of material deposits in the flowlines (e.g., in real-time) and effectuate remediation operations for removing the deposits, thereby improving productivity of said well operations.

Deposition control and remediation has traditionally been a challenging process, particularly in the context of offshore wells and subsea operations. For example, pigging systems may be used to deploy devices into a flowline to clean and monitor conditions in the flowline. Pigging systems can deploy devices from an onshore facility to the offshore well and from the offshore well back to the onshore facility, creating a pigging loop. Such pigging loops can involve a significant amount of additional material, can be expensive, and can be prone to failure. As a result, offshore subsea tiebacks often lack pigging loops. The lack of pigging loops in offshore subsea tiebacks increases the difficulty of deposition control and remediation. And while pigging a subsea flow line without a pigging loop is possible, such approaches are often very expensive since they require a boat, a remotely operated vehicle (ROV), or subsea pigging trap, each of which may significantly increase costs. Monitoring the effectiveness and optimization of a chemical program is also challenging due to a lack of understanding whether deposition is present and at what rate it may be occurring. A chemical program involves deploying a chemical substance in a flowline to remediate depositions within the flowline.

There are other challenges with monitoring deposit build-ups in flowlines, too. For example, it is possible to model the build-up of material in the flowlines, but the accuracy of such models is generally limited by the quality (e.g., accuracy) of the inputs to those models. One example of such inputs can be pressure information, which may be inaccurate in conventional systems. When a pressure signal is generated in a flowline, the pressure signal can traverse multiple fluid or gas boundaries due to changes in temperatures and pressure within the flowline, which can impact properties and behavior of the pressure signal. These changes may be calculated and derived for input into a model. Subsequent observations may be limited by the accuracy of the model and the inputs to the model.

In some examples, the model can include or be based on the Joukowsky water hammer equation (Eqn. 1) and the Darcy-Weisbach equation (Eqn. 2), which are expressed as:

$$Δ {p}_{j} = ρ * A V * μ \qquad ( 1 )$$

$${Δ}_{Pdw} = \frac{λ}{2} * \frac{Δ L}{d} * ρ * A {V}^{2} \qquad ( 2 )$$

where Δpⱼ is the Joukowsky water hammer magnitude, Δp_{dw} is the Darcy-Weisbach pressure loss, ρ is the fluid density, AV is the acoustic velocity, μ is the viscosity, λis the friction factor, ΔL is the segment length, and d is the inner diameter. Conventional modeling techniques that rely on the above equations can involve manual determination of potential changes in fluidic or gas behavior prior to calculation. The changes may be input into an iterative calculation for determining Δp, ΔL, and the resulting inner diameter d. Additionally, conventional modeling may involve a manual calculation of pressure head changes due to elevation impacts. As a result, the model may include hundreds of transitions with varying values for AV, d, λ, μ, and ρ.

Certain examples of the present disclosure involve a computing device executing a model and operations configured to improve the accuracy of detected deposits of material in fluid flowlines and mitigate such deposition. The model can be generated from multiple properties of the flowline. For example, the model can be generated based on platform information, flowline segment properties, fluid properties, transport materials, and treatment model properties. Examples of the segment properties can include total length, segment length, average segment length between welds, inner and outer diameters, construction material friction factors and elasticity, elevation profile, physical environment characteristics, joining mechanisms, and known obstructions or deposits of material. A pressure signal can then be generated in the flowline and the model can be adjusted based on a determination of one or more properties of a reflection of the pressure signal, to more accurately detect deposits of material in the flowline. For example, a timing and an amplitude of the reflected signal may be determined to improve the model.

Once adjusted, the model can be executed to determine an expected reflection signal, which can be compared to the received reflection signal to determine whether material has been deposited in the flowline. Along with determining the presence of the deposits of material, an amount of the deposits and the position of the deposits may also be determined. If a material deposit is detected in the flowline, the computing device can output a command for a remediation operation to remove the deposition. For example, the remediation operation may involve deploying a chemical package to the position of the deposition to remove the deposition.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

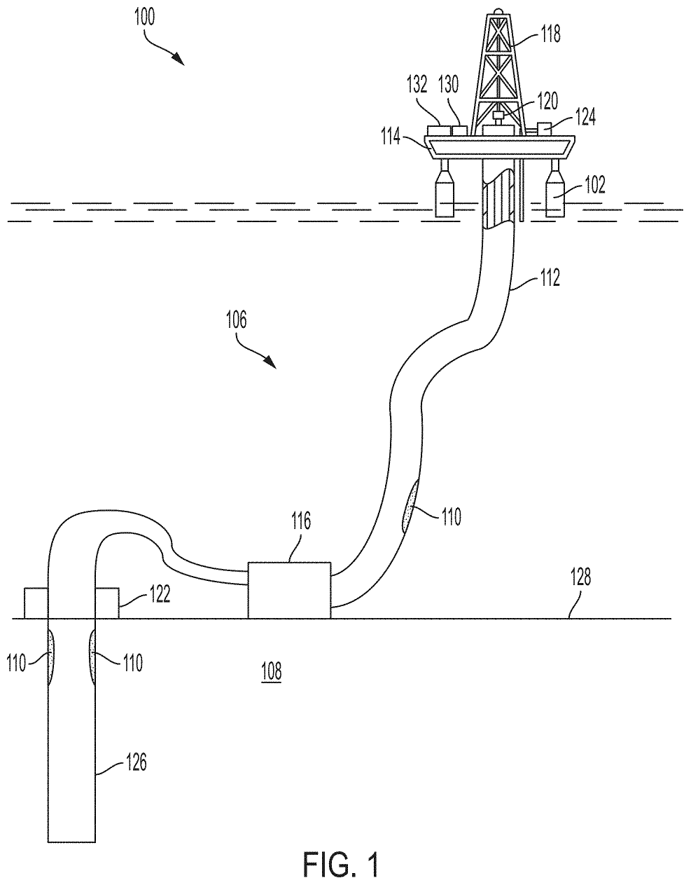

FIG. 1 is a schematic diagram of an off-shore wellbore environment 100 with a flowline 106 for carrying fluids according to one example of the present disclosure. The off-shore wellbore environment 100 can include a floating workstation 102 that can be positioned over a submerged oil or gas well located in a sea floor 128. The sea floor 128 can have a wellbore 126 extending from the sea floor 128 through a subterranean formation 108. The floating workstation 102 can have a derrick 118 and a hoisting apparatus 120 for raising and lowering tools to drill, test, and complete the oil or gas well. A pump 124 located on the deck 114 can exert fluid annulus pressure. The floating workstation 102 can be an oil platform as depicted in FIG. 1 or an aquatic vessel capable of performing the same or similar well operations. In some examples, the processes described herein can also be applied to a land-based context for wellbore exploration, planning, and drilling.

The flowline 106 can include a conduit 112 that can extend from a deck 114 of the floating workstation and through a manifold 116 and a blowout preventer 122 positioned on the sea floor 128. The flowline 106 can connect to the wellbore 126 that extends from the sea floor 128 into the subterranean formation 108. The flowline 106 can transport multi-phase fluids, which may include turbulence caused by air bubbles, unmixed substances, and substances of multiple phases. The manifold 116 can connect the conduit 112 to the blowout preventer 122. A tree may also be positioned along with the blowout preventer 122. The tree can manage fluids injected into the wellbore 126, while the blowout preventer 122 can prevent an uncontrolled release of gas or fluid from the wellbore 126. The flowline 106 can include one or more depositions 110, which can be particulates or other build-up in the flowline 106. The depositions 110 may interfere with well operations, and thus it may be advantageous to accurately determine a presence and position of the depositions 110.

Also included in the schematic diagram is a computing device 130. The computing device 130 can be communicatively coupled to a downhole tool and receive pressure information associated with the flowline 106. The computing device 130 may additionally be communicatively coupled to another computing device on-shore. The computing device 130 can monitor for depositions in the flowline 106 and output a command for a remediation operation in response to detecting a deposition.

A pressure controller 132 may be coupled to the computing device 130. The pressure controller 132 may include valves or other components for transmitting a pressure into the flowline 106. The computing device 130 can transmit commands to the pressure controller 132 for causing a valve or another device of the pressure controller 132 to generate a pressure signal in the flowline 106. An acoustic velocity or speed of the pressure signal generated by the pressure controller 132 may be influenced by the physical state of the fluid and the density of the fluid in the flowline 106. The frequency of the pressure signal can affect a rate of attenuation, which can impact whether the reflection of the pressure signal can provide desired information (e.g., whether the reflection signal will reach the computing device 130). Although generation of a pressure signal is described herein, other examples of the present disclosure can involve generation of a sound wave.

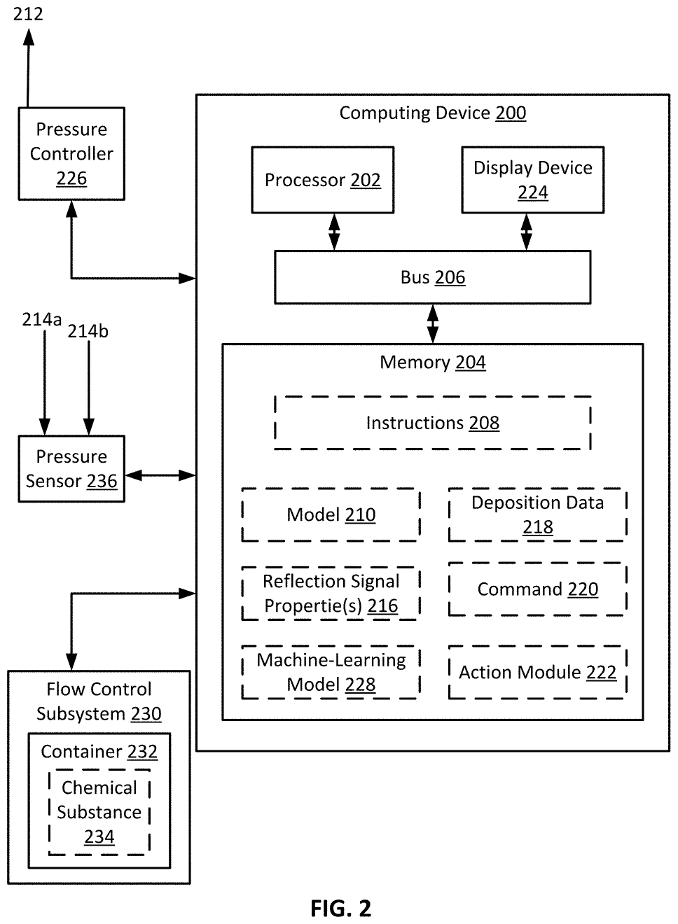

FIG. 2 is a block diagram of an example of a system for monitoring depositions in fluid flowlines according to one example of the present disclosure. The system can include a computing device 200 having a processor 202, a bus 206, a memory 204, and a display device 224. In some examples, the components shown in FIG. 2 can be integrated into a single structure. For example, the components can be within a single housing with a single processing device. In other examples, the components shown in FIG. 2 can be distributed (e.g., in separate housings) and in electrical communication with each other using various processors. It is also possible for the components to be distributed in a cloud computing system or grid computing system.

The processor 202 can execute one or more operations for determining an operating window. The processor 202 can execute instructions stored in the memory 204 to perform the operations. The processor 202 can include one processing device or multiple processing devices. Non-limiting examples of the processor 202 include a field-programmable gate array (“FPGA”), an application-specific integrated circuit (“ASIC”), a processor, a microprocessor, etc.

The processor 202 is communicatively coupled to the memory 204 via the bus 206. The memory 204 may include any type of memory device that retains stored information when powered off. Non-limiting examples of the memory 204 include electrically erasable and programmable read-only memory (“EEPROM”), flash memory, or any other type of non-volatile memory. In some examples, at least some of the memory 204 can include a non-transitory medium from which the processor 202 can read instructions. A computer-readable medium can include electronic, optical, magnetic, or other storage devices capable of providing the processor 202 with computer-readable instructions or other program code. Non-limiting examples of a computer-readable medium include (but are not limited to) magnetic disk(s), memory chip(s), read-only memory (ROM), random-access memory (“RAM”), an ASIC, a configured processing device, optical storage, or any other medium from which a computer processing device can read instructions. The instructions can include processing device-specific instructions generated by a compiler or an interpreter from code written in any suitable computer-programming language, including, for example, C, C++, C#, etc.

In some examples, the computing device 200 includes a display device 224. The display device 224 can represent one or more components used to output data. Examples of the display device 224 can include a liquid-crystal display (LCD), a computer monitor, a touch-screen display, etc.

To monitor for a deposition in a flowline (e.g., a subsea flowline) of a well system, the computing device 200 may generate a model 210 of some or all of the flowline. The model 210 can indicate expected transitions and boundaries in the fluid in the flowline. The computing device 200 can generate the model 210 based on properties of the flowline and properties of the floating workstation. For example, the properties can include platform information, physical properties of the flowline, fluid properties, properties of transport materials, and properties of treatment models. Examples of the platform information associated with a subsea flowline can include a height of the subsea conduit above sea level; a height of a high-fidelity tie-in port above sea level; and information about a pump exerting fluid annulus pressure, such as pump rate, pump frequency, and pump horsepower. Examples of the physical properties of the flowline can include a total length and segment length, an average segment length between welds or joins, an inner diameter and an outer diameter of the flowline, a construction material, friction factors and elasticity, and an elevation profile. Each of these properties can be determined for a respective span of the flowline that is between the floating workstation and the manifold, inside the manifold, between the manifold and the blowout preventer, and from the blowout preventer down the wellbore. The physical properties of the flowline may additionally include physical environment properties (e.g., above ground, below ground, or subsea), joining mechanism(s) and positions, and known obstructions or depositions. Examples of the fluid properties can include temperature, viscosity, density, compressibility, anticipated flow regime, and chemical assay results. Each of the fluid properties may be evaluated along the same paths as the physical properties of the flowline. Examples of the properties of transport materials and treatment models can include friction factors and treatments, inhibitor treatments, and acids. Similarly, these properties may be evaluated along the same paths as the physical properties of the flowline.

The model 210 may include or be based on the Joukowsky, Darcy-Weisbach, and Bernoulli equations represented as:

$$h = \frac{A {V}^{2}}{2} + g z + ( \frac{γ}{γ - 1} ) * \frac{p}{ρ} \qquad ( 3 )$$

where h is the pressure head, AV is the acoustic velocity, g is gravity, z is the elevation of a point above a reference plane, γ is the ratio of specific heats, p is the pressure, and ρ is the density of the fluid. The model 210 of Eqn. 3 can generate an expected reflection signal based on a generation of a water hammer. A water hammer is a pressure surge that results from a fluid being forced to stop or change direction. For example, the pressure, acoustic velocity, gravity, elevation, ration of specific heats, and density of the fluid can be fed into Eqn. 3 to determine the pressure head, which corresponds to the expected reflection signal. The model 210 may additionally use other techniques, along with Eqn. 3, to determine the expected reflection signal. For example, the model 210 can use signal processing of a pressure signal and characteristics of the pressure signal's first and second order derivatives to determine peak detection and physical significance of the pressure signal and the expected reflection signal.

The computing device 200 can then control the transmission of a pressure signal 212 downhole into the flowline. For example, the computing device 200 may output a command to a pressure controller 226 that can be coupled to the computing device 200. The pressure controller 226 can include valves and other components. The pressure controller 226 can receive the command from the computing device 200 and control a valve (e.g., at the floating workstation or elsewhere) or another component to generate and transmit the pressure signal 212 into the flowline. The computing device 200 can determine a strength for the pressure signal 212 to ensure the pressure signal 212 can traverse physical changes, fluid or gas composition changes due to flow line intersections, and changes in flow regime due to flow lines or other pipeline features. In some examples, the computing device 200 may use an inverse simulation model that accounts for the potential changes, to determine the strength of the pressure signal 212 and expected values at positions along the flowline. An inverse simulation model can determine values for input variables that correspond to known output values. The computing device 200 may then operate the pressure controller 226 such that the pressure signal 212 has the target signal strength.

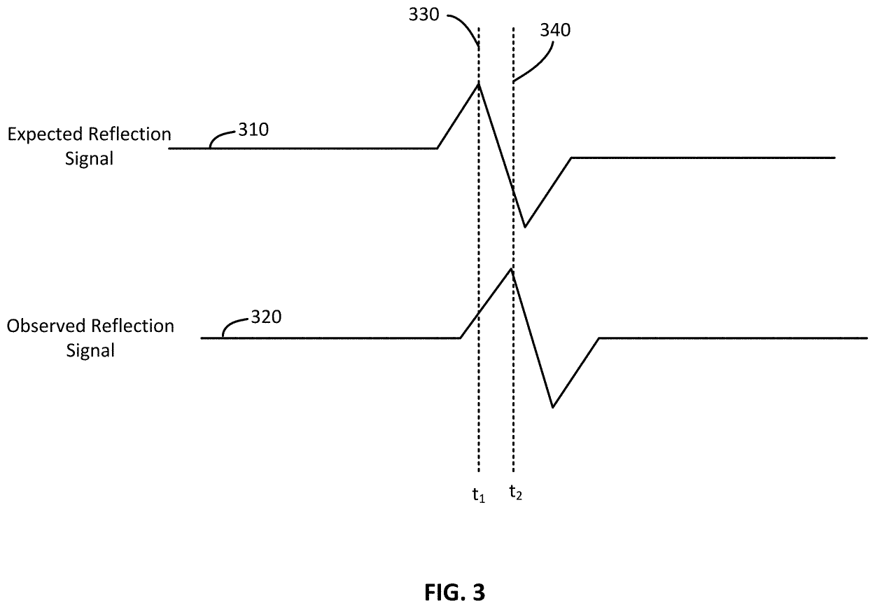

In some examples, a pressure sensor 236 coupled to the computing device 200 can receive a reflection signal 214a indicating a reflection of the pressure signal 212 from the flowline. Examples of the pressure sensor 236 can include a strain gauge, a capacitive sensor, a piezoelectric sensor, and an optical sensor. The pressure sensor 236 can detect the reflection signal 214a and transmit a sensor signal indicative of the reflection signal 214a to the computing device 200. The sensor signal can indicate properties (e.g., timing, amplitude, waveform, etc.) of the reflection signal 214a to the computing device 200. The computing device 200 can then determine at least one reflection signal property 216 that can be used to adjust the model 210 to increase its accuracy. For example, the computing device 200 may determine a timing of the reflection signal 214a or an amplitude from the reflection signal 214a. The determination can be conducted with respect to known features within the flowline, such as a manifold, or blowout preventer, where expected pressure variations may be created due to changes in physical infrastructure. As a result of the pressure variations, the reflection signal 214a may vary from an expected reflection signal determined by the model 210, and thus the model 210 can be adjusted to account for the difference. Adjusting the model 210 may improve the accuracy of future calculations of the wellbore operation. The computing device 200 can use the adjusted model to determine whether a deposition is present in a flowline and use an action module 222 to implement remediation operations for detected depositions. The process of adjusting the model 210 is further described with respect to FIG. 3 below.

FIG. 3 is a diagram of an example of an expected reflection signal and an observed reflection signal according to some aspects of the present disclosure. Aspects of FIG. 3 are described below with reference to the components shown in FIG. 2. The computing device 200 can generate an expected reflection signal 310 using the model 210. The expected reflection signal 310 can include an expected timing of pressure variations in the reflection signal 214a. The computing device 200 can then receive an observed reflection signal 320, which corresponds to the reflection signal 214a. From the observed reflection signal 320, the computing device 200 can determine an observed timing of the pressure variations in the reflection signal 214a. For example, the expected reflection signal 310 can indicate an expected maximum pressure at time t₁ 330, and the observed reflection signal 320 can indicate the maximum pressure occurs at time t₂ 340. The computing device 200 can then adjust the model 210 to account for the difference between the expected timing and the observed timing of the pressure variations in the reflection signal 214a. Adjusting the model 210 can incorporate unknown impacts and associated time lags (t₁−t₂) determined from the observed reflection signal 320. The unknown impacts may include changes (e.g., friction factor changes resulting from un-modeled welds) due to small, existing deposits from other known processes (e.g., welding) between an origination point of the pressure signal 212 and the position of the known feature. The calibration may enable the impact of these existing features to be minimized, so that the system can more accurately detect material deposits (e.g., deposits occurring at points downstream from these known features).

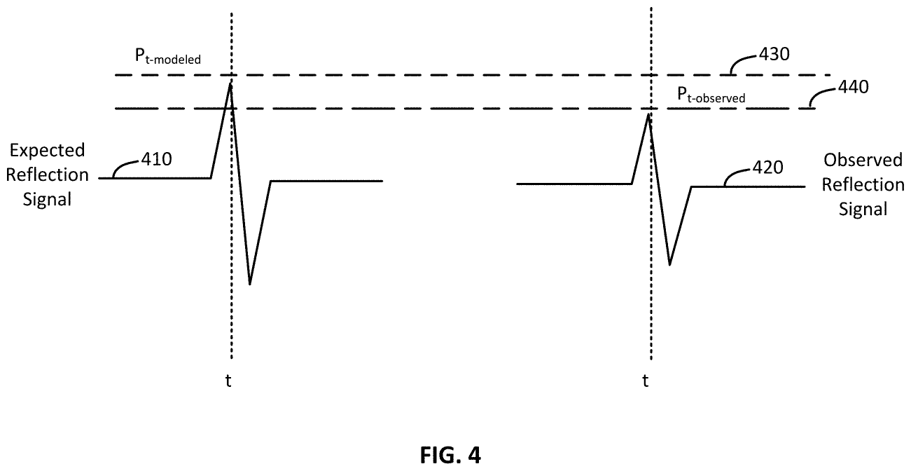

FIG. 4 is a diagram of an example of an expected reflection signal and an observed reflection signal according to some aspects of the present disclosure. Aspects of FIG. 4 are described below with reference to the components shown in FIG. 2. The computing device 200 uses the model 210 to generate an expected reflection signal 410 of expected pressure amplitudes at points along the flowline under nominal conditions. The computing device 200 can then compare the expected pressure amplitudes to observed pressure amplitudes in an observed reflection signal 420, which may correspond to the reflection signal 214a of FIG. 2. For example, the expected reflection signal 410 can indicate an expected pressure measurement 430 at time t, and the observed reflection signal 420 can indicate a different pressure measurement 440 at time t. The unexplained pressure variation at time t (Δp_{delta}) can then be expressed as:

ΔP_{delta}=abs(P_{t-model}−P_{t-observed}±hₜ) (4)

where P_{t-model} is the expected pressure measurement at time t, P_{t-observed} is the observed pressure measurement at time t, and hₜ is the pressure head at time t. The computing device 200 can then compare the differences in the pressure measurements.

In some examples, the computing device 200 can use a machine-learning model 228 to analyze some or all of the pressure measurements in the expected reflection signal, the observed reflection signal, or both. Examples of the machine-learning model 228 can include a neural network such as a deep neural network; a classifier such as a Naive Bayes classifier; or a combination thereof. The computing device 200 may, for example, execute the machine-learning model 228 to compare the observed pressure measurements against pressure profiles, such as previous pressure profiles or pressure profiles based on expected outcomes from changes based on fluid and gas transitions in similar scenarios. The computing device 200 can accurately evaluate the expected reflection signal 410 versus the observed reflection signal 420 and adjust the model 210 to capture the differences in the pressure measurements. Subsequent updates can then be made to the model 210 prior to future deposition calculations, resulting in more accurate deposition detections in the future.

Returning to FIG. 2, having generated and adjusted the model 210, the computing device 200 may then use the model 210 to determine a presence of an unknown deposition in the flowline. To do this, the computing device 200 can operate the pressure controller 226 to generate pressure signal 212 in the flowline. The computing device can also determine an expected reflection signal using the adjusted model 210. Additionally, the computing device 200 can receive sensor data indicating properties of a reflection signal 214b associated with the pressure signal 212. The computing device 200 can then determine differences between the expected reflection signal and the reflection signal 214b by comparing the properties of the expected reflection signal to the properties of the reflection signal 214b. The differences can then be used to determine the presence of a deposition in the flowline, along with a position and an amount of the deposition. For example, the computing device 200 can determine the presence of the deposition and the characteristics of the deposition, which can be stored as deposition data 218, using a combination of Joukowsky, Darcy-Weisbach, and Bernoulli equations, expressed as:

$${d}_{t} = \frac{\frac{{λ}_{t}}{2} * Δ {L}_{t} * {p}_{t} * A {V}_{t}^{2}}{( {ρ}_{t} {AV}_{t} * {μ}_{t} - Δ {P}_{t - observed} \pm {h}_{t}} \qquad ( 5 )$$

where dₜ is the diameter at time t, is the friction factor at time t, μₜ is the viscosity at time t, AV is the acoustic velocity at time t, hₜ is the pressure head at time t, ΔLₜ is the segment length at time t, ρₜ is the density of the fluid at time t, and ΔP_{t-observed} is the observed pressure variance at time t. The thickness of the deposition can be determined from subtracting dₜ from the original inner diameter of the flowline.

In response to determining the presence of the deposition, in some examples the computing device 200 can execute an action module 222. The action module 222 can be software configured to initiate (e.g., automatically initiate) a remediation operation that is configured to reduce or eliminate the deposition. For example, the action module 222 can generate a command 220 indicating that a targeted amount of substance (e.g., a chemical package) is to be deployed to the position of the deposition. The targeted amount of substance can be determined based on the amount of the deposition 218. The substance can be configured to remove (e.g., dissolve) the deposition to improve the drilling operation. The computing device 200 can then transmit the command 220 to a flow control subsystem 230, which can be used to implement the remediation operation defined in the command 220. The computing device 200 can be in communication with the flow control subsystem 230, which may include valves or other equipment that can be operated by the computing device 200. The flow control subsystem 230 may additionally be attached to a container 232 with a chemical substance 234 for dissolving the deposition. An example of the chemical substance 234 can be an acidic substance. The flow control subsystem 239 can receive the command 220 from the computing device 200 and responsively convey the chemical substance 234 into the flowline to dissolve away the deposition.

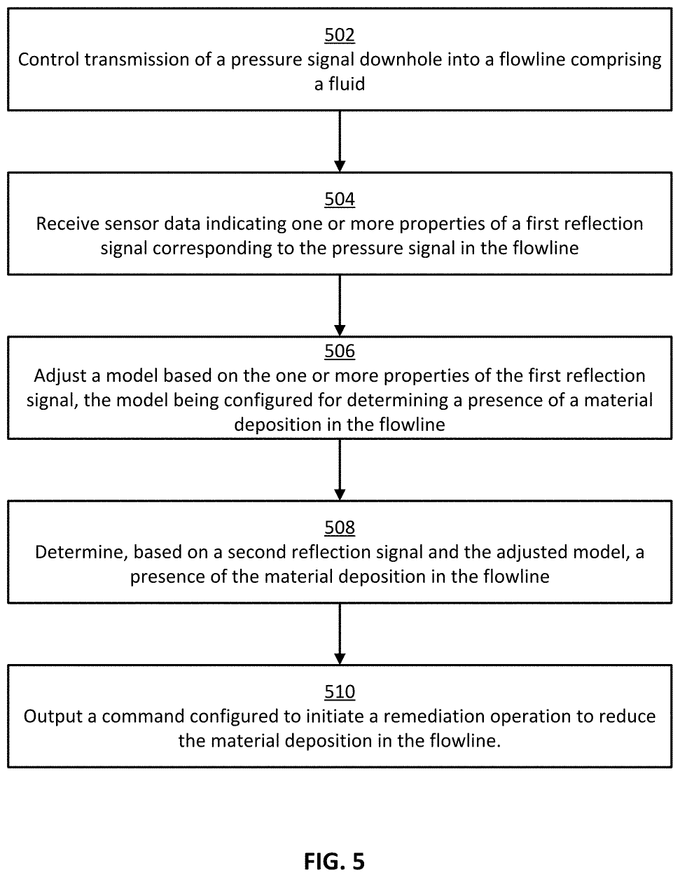

In some examples, the computing device 200 can implement the process shown in FIG. 5 for effectuating some aspects of the present disclosure. Other examples can involve more operations, fewer operations, different operations, or a different order of the operations shown in FIG. 5. The operations of FIG. 5 are described below with reference to the components shown in FIG. 2.

At block 502, the processor 202 can control transmission of a pressure signal 212 into a flowline that includes a fluid (e.g., a multi-phase fluid) associated with a well operation. This may involve the processor 202 operating a pressure controller 226 to generate the pressure signal in the flowline. The processor 202 can determine a target strength for the pressure signal 212 that is sufficiently large to travel down the flowline and generate a reflection signal that can return to the origin point. The processor 202 can then control the transmission such that the pressure signal 212 is generated to have the target strength.

At block 504, the processor 202 can receive sensor data indicating properties 216 of a reflection signal 214a, which is a reflection of the pressure signal 212 in the flowline. The reflection signal 214a may be for an entirety of the flowline or for a portion of the flowline, such as from the floating workstation to a manifold, from the manifold to a blowout preventer, from the blowout preventer to a bottom of a wellbore, or a combination thereof. The processor 202 may determine a timing of the reflection signal 214a, an amplitude, or another characteristic of the reflection signal 214a. Based on the at least one property 216, the processor 202 can determine differences between expected properties and observed properties.

At block 506, the processor 202 can adjust a model 210 based on the at least one property 216 of the reflection signal 214a. The model 210 can be configured for determining a presence of a deposition in a flowline. Adjusting the model 210 may more accurately represent the flowline. The model 210 may initially be generated based on physical properties of the flowline.

At block 508, the processor 202 can determine, based on another reflection signal 214b and the adjusted model 210, a presence of the deposition 218. To do so, the processor 202 can operate the pressure controller 226 to transmit another pressure signal into the same flowline or a different flowline and receive sensor data indicating properties of the other reflection signal 214b. The processor 202 can use the adjusted model 210 to generate an expected reflection signal and then compare the expected reflection signal to the observed reflection signal 214b received from the flowline to determine the presence of the deposition. The processor 202 may additionally determine an amount of the deposition and a position of the deposition based on the comparison. The presence of the deposition and characteristics of the deposition can be stored as deposition data 218.

At block 510, the processor 202 can output a command 220 for initiating a remediation operation configured to reduce (e.g., eliminate) the deposition. For example, the processor 202 can determine a targeted amount of substance that can remove the deposition. The processor 202 can then output the command 220 to a flow control subsystem 230 for deploying the targeted amount of substance to the position of the deposition to remove the deposition. Proactively removing the deposition before a full blockage occurs in the flowline may improve resource usage and productivity of a well operation.

In some aspects, a system, a method, and a non-transitory computer-readable medium for monitoring depositions in fluid flowlines during wellbore operations are provided according to one or more of the following examples. As used below, any reference to a series of examples is to be understood as a reference to each of those examples disjunctively (e.g., “Examples 1-4” is to be understood as “Examples 1, 2, 3, or 4”).

Example 1 is a system comprising: a processor; and a memory including instructions executable by the processor for causing the processor to: control transmission of a pressure signal subsea into a flowline comprising a fluid; receive sensor data indicating one or more properties of a first reflection signal corresponding to the pressure signal in the flowline; adjust a model based on the one or more properties of the first reflection signal, the model being configured for determining a presence of a material deposition in the flowline; determine, based on a second reflection signal and the adjusted model, a presence of the material deposition in the flowline; and output a command configured to initiate a remediation operation to reduce the material deposition in the flowline.

Example 2 is the system of Example 1, wherein the memory further includes instructions that are executable by the processor for causing the processor to adjust the model based on the one or more properties of the first reflection signal by, prior to determining the presence of the material deposition: generating, by executing the model, an expected timing of pressure variations in the first reflection signal based on a plurality of properties of the flowline; determining an observed timing of the pressure variations in the first reflection signal; and adjusting the model to account for a difference between the expected timing and the observed timing of the pressure variations in the first reflection signal.

Example 3 is the system of any of Examples 1-2, wherein the memory further includes instructions that are executable by the processor for causing the processor to adjust the model based on the one or more properties of the first reflection signal by, prior to determining the presence of the material deposition: generating, by executing the model, an expected amplitude of the first reflection signal based on a plurality of properties of the flowline; determining an observed amplitude of the first reflection signal; and adjusting the model to account for a difference between the expected amplitude and the observed amplitude associated with the first reflection signal.

Example 4 is the system of Example 3, wherein the memory further includes instructions that are executable by the processor for causing the processor to adjust the model by: comparing the expected amplitude and the observed amplitude to an additional expected amplitude generated by a machine-learning model; and adjusting the model based on the expected amplitude, the observed amplitude, and the additional expected amplitude.

Example 5 is the system of any of Examples 1-4, wherein the memory further includes instructions that are executable by the processor for causing the processor to determine the presence of the material deposition by: determining, by executing the model, expected properties of a reflection signal based on a plurality of physical properties of the flowline; determining observed properties of the second reflection signal; and comparing the expected properties to the observed properties.

Example 6 is the system of any of Examples 1-5, wherein the memory further includes instructions that are executable by the processor for causing the processor to determine a position of the material deposition in the flowline and an amount of the material deposition, and wherein the remediation operation comprises deploying a targeted amount of substance to the position to remove the material deposition.

Example 7 is the system of any of Examples 1-6, wherein the memory further includes instructions that are executable by the processor for causing the processor to operate a pressure controller to generate the pressure signal in the flowline.

Example 8 is the system of any of Examples 1-7, wherein the memory further includes instructions that are executable by the processor for causing the processor to operate a flow control subsystem to transmit a substance to the material deposition in the flowline for dissolving the material deposition.

Example 9 is a method comprising: controlling, by a computing device, transmission of a pressure signal subsea into a flowline comprising a fluid; receiving, by the computing device, sensor data indicating one or more properties of a first reflection signal corresponding to the pressure signal in the flowline; adjusting, by the computing device, a model based on the one or more properties of the first reflection signal, the model being configured for determining a presence of a material deposition in the flowline; determining, by the computing device and based on a second reflection signal and the adjusted model, a presence of the material deposition in the flowline; and outputting, by the computing device, a command configured to initiate a remediation operation to reduce the material deposition in the flowline.

Example 10 is the method of Example 9, further comprising adjusting the model based on the one or more properties of the first reflection signal by, prior to determining the presence of the material deposition: generating, by executing the model, an expected timing of pressure variations in the first reflection signal based on a plurality of properties of the flowline; determining an observed timing of the pressure variations in the first reflection signal; and adjusting the model to account for a difference between the expected timing and the observed timing of the pressure variations in the first reflection signal.

Example 11 is the method of any of Examples 9-10, further comprising adjusting the model based on the one or more properties of the first reflection signal by, prior to determining the presence of the material deposition: generating, by executing the model, an expected amplitude of the first reflection signal based on a plurality of properties of the flowline; determining an observed amplitude of the first reflection signal; and adjusting the model to account for a difference between the expected amplitude and the observed amplitude associated with the first reflection signal.

Example 12 is the method of Example 11, further comprising adjusting the model by: comparing the expected amplitude and the observed amplitude to an additional expected amplitude generated by a machine-learning model; and adjusting the model based on the expected amplitude, the observed amplitude, and the additional expected amplitude.

Example 13 is the method of any of Examples 9-12, further comprising determining the presence of the material deposition by: determining, by executing the model, expected properties of a reflection signal based on a plurality of physical properties of the flowline; determining observed properties of the second reflection signal; and comparing the expected properties to the observed properties.

Example 14 is the method of any of Examples 9-13, further comprising determining a position of the material deposition in the flowline and an amount of the material deposition, and wherein the remediation operation comprises deploying a targeted amount of substance to the position to remove the material deposition.

Example 15 is the method of any of Examples 9-14, further comprising operating a pressure controller to generate the pressure signal in the flowline.

Example 16 is the method of any of Examples 9-15, further comprising operating a flow control subsystem to transmit a substance to the material deposition in the flowline for dissolving the material deposition.

Example 17 is a non-transitory computer-readable medium comprising instructions that are executable by a processing device for causing the processing device to perform operations comprising: controlling transmission of a pressure signal subsea into a flowline comprising a fluid; receiving sensor data indicating one or more properties of a first reflection signal corresponding to the pressure signal in the flowline; adjusting a model based on the one or more properties of the first reflection signal, the model being configured for determining a presence of a material deposition in the flowline; determining, based on a second reflection signal and the adjusted model, a presence of the material deposition in the flowline; and outputting a command configured to initiate a remediation operation to reduce the material deposition in the flowline.

Example 18 is the non-transitory computer-readable medium of Example 17, further comprising instructions that are executable by the processing device for causing the processing device to adjust the model based on the one or more properties of the first reflection signal by, prior to determining the presence of the material deposition: generating, by executing the model, an expected timing of pressure variations in the first reflection signal based on a plurality of properties of the flowline; determining an observed timing of the pressure variations in the first reflection signal; and adjusting the model to account for a difference between the expected timing and the observed timing of the pressure variations in the first reflection signal.

Example 19 is the non-transitory computer-readable medium of any of Examples 17-18, further comprising instructions that are executable by the processing device for causing the processing device to adjust the model based on the one or more properties of the first reflection signal by, prior to determining the presence of the material deposition: generating, by executing the model, an expected amplitude of the first reflection signal based on a plurality of properties of the flowline; determining an observed amplitude of the first reflection signal; and adjusting the model to account for a difference between the expected amplitude and the observed amplitude in the first reflection signal.

Example 20 is the non-transitory computer-readable medium of any of Examples 17-19, further comprising instructions that are executable by the processing device to cause the processing device to determine the presence of the material deposition by: determining, by executing the model, expected properties of a reflection signal based on a plurality of physical properties of the flowline; determining observed properties of the second reflection signal; and comparing the expected properties to the observed properties.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processor; and
a memory including instructions executable by the processor for causing the processor to:
control transmission of a pressure signal subsea into a flowline comprising a fluid;
receive sensor data indicating one or more properties of a first reflection signal corresponding to the pressure signal in the flowline;
adjust a model based on the one or more properties of the first reflection signal, the model being configured for determining a presence of a material deposition in the flowline;
determine, based on a second reflection signal and the adjusted model, a presence of the material deposition in the flowline; and
output a command configured to initiate a remediation operation to reduce the material deposition in the flowline.

2. The system of claim 1, wherein the memory further includes instructions that are executable by the processor for causing the processor to adjust the model based on the one or more properties of the first reflection signal by, prior to determining the presence of the material deposition:
generating, by executing the model, an expected timing of pressure variations in the first reflection signal based on a plurality of properties of the flowline;
determining an observed timing of the pressure variations in the first reflection signal; and
adjusting the model to account for a difference between the expected timing and the observed timing of the pressure variations in the first reflection signal.

3. The system of claim 1, wherein the memory further includes instructions that are executable by the processor for causing the processor to adjust the model based on the one or more properties of the first reflection signal by, prior to determining the presence of the material deposition:
generating, by executing the model, an expected amplitude of the first reflection signal based on a plurality of properties of the flowline;
determining an observed amplitude of the first reflection signal; and
adjusting the model to account fora difference between the expected amplitude and the observed amplitude associated with the first reflection signal.

4. The system of claim 3, wherein the memory further includes instructions that are executable by the processor for causing the processor to adjust the model by:
comparing the expected amplitude and the observed amplitude to an additional expected amplitude generated by a machine-learning model; and
adjusting the model based on the expected amplitude, the observed amplitude, and the additional expected amplitude.

5. The system of claim 1, wherein the memory further includes instructions that are executable by the processor for causing the processor to determine the presence of the material deposition by:
determining, by executing the model, expected properties of a reflection signal based on a plurality of physical properties of the flowline;
determining observed properties of the second reflection signal; and
comparing the expected properties to the observed properties.

6. The system of claim 1, wherein the memory further includes instructions that are executable by the processor for causing the processor to determine a position of the material deposition in the flowline and an amount of the material deposition, and wherein the remediation operation comprises deploying a targeted amount of substance to the position to remove the material deposition.

7. The system of claim 1, wherein the memory further includes instructions that are executable by the processor for causing the processor to operate a pressure controller to generate the pressure signal in the flowline.

8. The system of claim 1, wherein the memory further includes instructions that are executable by the processor for causing the processor to operate a flow control subsystem to transmit a substance to the material deposition in the flowline for dissolving the material deposition.

9. A method comprising:
controlling, by a computing device, transmission of a pressure signal subsea into a flowline comprising a fluid;
receiving, by the computing device, sensor data indicating one or more properties of a first reflection signal corresponding to the pressure signal in the flowline;
adjusting, by the computing device, a model based on the one or more properties of the first reflection signal, the model being configured for determining a presence of a material deposition in the flowline;
determining, by the computing device and based on a second reflection signal and the adjusted model, a presence of the material deposition in the flowline; and
outputting, by the computing device, a command configured to initiate a remediation operation to reduce the material deposition in the flowline.

10. The method of claim 9, further comprising adjusting the model based on the one or more properties of the first reflection signal by, prior to determining the presence of the material deposition:
generating, by executing the model, an expected timing of pressure variations in the first reflection signal based on a plurality of properties of the flowline;
determining an observed timing of the pressure variations in the first reflection signal; and
adjusting the model to account for a difference between the expected timing and the observed timing of the pressure variations in the first reflection signal.

11. The method of claim 9, further comprising adjusting the model based on the one or more properties of the first reflection signal by, prior to determining the presence of the material deposition:
generating, by executing the model, an expected amplitude of the first reflection signal based on a plurality of properties of the flowline;
determining an observed amplitude of the first reflection signal; and
adjusting the model to account for a difference between the expected amplitude and the observed amplitude associated with the first reflection signal.

12. The method of claim 11, further comprising adjusting the model by:
comparing the expected amplitude and the observed amplitude to an additional expected amplitude generated by a machine-learning model; and
adjusting the model based on the expected amplitude, the observed amplitude, and the additional expected amplitude.

13. The method of claim 9, further comprising determining the presence of the material deposition by:
determining, by executing the model, expected properties of a reflection signal based on a plurality of physical properties of the flowline;
determining observed properties of the second reflection signal; and
comparing the expected properties to the observed properties.

14. The method of claim 9, further comprising determining a position of the material deposition in the flowline and an amount of the material deposition, and wherein the remediation operation comprises deploying a targeted amount of substance to the position to remove the material deposition.

15. The method of claim 9, further comprising operating a pressure controller to generate the pressure signal in the flowline.

16. The method of claim 9, further comprising operating a flow control subsystem to transmit a substance to the material deposition in the flowline for dissolving the material deposition.

17. A non-transitory computer-readable medium comprising instructions that are executable by a processing device for causing the processing device to perform operations comprising:
controlling transmission of a pressure signal subsea into a flowline comprising a fluid;
receiving sensor data indicating one or more properties of a first reflection signal corresponding to the pressure signal in the flowline;
adjusting a model based on the one or more properties of the first reflection signal, the model being configured for determining a presence of a material deposition in the flowline;
determining, based on a second reflection signal and the adjusted model, a presence of the material deposition in the flowline; and
outputting a command configured to initiate a remediation operation to reduce the material deposition in the flowline.

18. The non-transitory computer-readable medium of claim 17, further comprising instructions that are executable by the processing device for causing the processing device to adjust the model based on the one or more properties of the first reflection signal by, prior to determining the presence of the material deposition:
generating, by executing the model, an expected timing of pressure variations in the first reflection signal based on a plurality of properties of the flowline;
determining an observed timing of the pressure variations in the first reflection signal; and
adjusting the model to account for a difference between the expected timing and the observed timing of the pressure variations in the first reflection signal.

19. The non-transitory computer-readable medium of claim 17, further comprising instructions that are executable by the processing device for causing the processing device to adjust the model based on the one or more properties of the first reflection signal by, prior to determining the presence of the material deposition:
generating, by executing the model, an expected amplitude of the first reflection signal based on a plurality of properties of the flowline;
determining an observed amplitude of the first reflection signal; and
adjusting the model to account for a difference between the expected amplitude and the observed amplitude in the first reflection signal.

20. The non-transitory computer-readable medium of claim 17, further comprising instructions that are executable by the processing device to cause the processing device to determine the presence of the material deposition by:
determining, by executing the model, expected properties of a reflection signal based on a plurality of physical properties of the flowline;
determining observed properties of the second reflection signal; and
comparing the expected properties to the observed properties.
